(19) United States
(12) Patent Application Publication
(10) Pub. No.: US 2014/0255006 A1
(43) Pub. Date: Sep. 11, 2014

(54) CONTENT REPRODUCTION APPARATUS AND STORAGE MEDIUM

(71) Applicant: SONY CORPORATION, Tokyo (JP)

(72) Inventors: YOICHIRO SAKO, Tokyo (JP); MITSURU TAKEHARA, Tokyo (JP)

(73) Assignee: SONY CORPORATION, Tokyo (JP)

(21) Appl. No.: 14/191,027

(22) Filed: Feb. 26, 2014

(30) Foreign Application Priority Data
Mar. 8, 2013 (JP) 2013-046263

(51) Int. Cl. H04N 9/87

(52) U.S. Cl. CPC H04N 9/87
USPC 386/248

(57) ABSTRACT

There is provided a content reproduction apparatus including an identification unit configured to identify a series of pieces of content that were recorded or reproduced in chronological order, an acquisition unit configured to acquire sequence information that shows time sequence of the series of pieces of content identified by the identification unit a setting unit configured to set respective reproduction timings of the pieces of content reproduced in a sequence corresponding to the sequence information and a reproduction control unit configured to perform control so as to reproduce the identified pieces of content at the reproduction timings set by the setting unit.

### CROSS REFERENCE TO RELATED APPLICATIONS

This application claims the benefit of Japanese Priority Patent Application JP 2013-046263 filed Mar. 8, 2013, the entire contents of which are incorporated herein by reference.

### BACKGROUND

The present disclosure relates to a content reproduction apparatus and a storage medium.

There are known various techniques about providing various types of content such as a television program, radio program, music, drama, and the like.

For example, JP 2004-524769A discloses a system for providing an electronic program guide for television or radio programs including presenting listings of past programs on a screen and indicating whether the past programs are available again at a future time.

JP 2007-11928A discloses a content distribution server including searching for a content item stored in a content storage unit according to a search condition based on time information and accompanying information included in a content providing request, and distributing the searched content item to the content receiving terminal.

JP 2005-31830A discloses a technique including specifying ages corresponding to each period of a user from a birthdate of the user, grouping image frames for each period based on date information specifying date on which the image frames are taken, reading image frames belonging to a selected period, and display the read image frames on a display panel. This is effective in searching for the image frames desired by the user with high efficiency, in the case of digital versatile disc (DVD).

### SUMMARY

However, JP 2004-524769A, JP 2007-11928 A, and JP 2005-31830A do not refer to reproduction of a series of pieces of content in consideration of time schedules at the times, the series of pieces of content including events taking place over multiple days such as Olympics and World Cups, a series of television programs such as serial dramas and anime series, and the like.

When the past events, the past television programs and the like can be reproduced with the inclusion of time intervals (intervals between games in an event, intervals between television programs, and the like) in consideration of time schedules at the times, realistic sensation can be created more and entertainment characteristics can be improved.

Therefore, the present disclosure proposes a novel and enhanced content reproduction apparatus and recording medium that are able to set reproduction timings of a series of pieces of content that were recorded and reproduced in chronological order.

According to an embodiment of the present disclosure, there is provided a content reproduction apparatus including an identification unit configured to identify a series of pieces of content that were recorded or reproduced in chronological order, an acquisition unit configured to acquire sequence information that shows time sequence of the series of pieces of content identified by the identification unit, a setting unit configured to set respective reproduction timings of the pieces of content reproduced in a sequence corresponding to the sequence information, and a reproduction control unit configured to perform control so as to reproduce the identified pieces of content at the reproduction timings set by the setting unit.

According to an embodiment of the present disclosure, there is provided a non-transitory computer-readable storage medium having a program stored therein, the program for causing a computer to function as, an identification unit configured to identify a series of pieces of content that were recorded or reproduced in chronological order, an acquisition unit configured to acquire sequence information that shows time sequence of the series of pieces of content identified by the identification unit, a setting unit configured to set respective reproduction timings of the pieces of content reproduced in a sequence corresponding to the sequence information, and a reproduction control unit configured to perform control so as to reproduce the identified pieces of content at the reproduction timings set by the setting unit.

As described above, according to the present disclosure, it is possible to set reproduction timings of a series of pieces of content that were recorded and reproduced in chronological order.

### BRIEF DESCRIPTION OF THE DRAWINGS

FIG. 1 is an explanatory diagram showing an appearance of a content reproduction apparatus realizing a reproduction system according to an embodiment of the present disclosure;

FIG. 2 is a block diagram showing an internal configuration of a content reproduction apparatus according to a first embodiment;

FIG. 3 is a diagram showing an example of various types of content stored in a content DB;

FIG. 4 is a diagram illustrating an example of setting of reproduction timings based on actual time intervals;

FIG. 5 is a flowchart showing operation processing in a case where the content reproduction apparatus according to the first embodiment reproduces a past event;

FIG. 6 is a flowchart showing operation processing in a case where the content reproduction apparatus according to the first embodiment reproduces a past television program;

FIG. 7 is a diagram showing entire configurations of a reproduction system according to a second embodiment;

FIG. 8 is a block diagram showing a configuration of a content reproduction apparatus according to the second embodiment; and

FIG. 9 is a sequence diagram showing reproduction timing setting processing performed by the content reproduction apparatus according to the second embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Further, in this specification and the appended drawings, there are some cases where multiple structural elements that have substantially the same function and structure are distinguished from one another by being denoted with different alphabets after the same reference numeral. Note that, in the case where it is not necessary to distinguish the multiple structural elements that have substantially the same function and structure from one another, the multiple structural elements are denoted with the same reference numeral only.

Note that description will be provided in the following order.
1. Brief description of reproduction system
2. First embodiment

2-1. Configuration of content reproduction apparatus according to first embodiment

2-2. Operation of content reproduction apparatus according to first embodiment
3. Second embodiment
4. Conclusion

### 1. Brief Description of Reproduction System

A technique according to embodiments of the present disclosure can be implemented in various ways as specifically described in “2. First embodiment” to “3. Second embodiment”, as an example. Also, a content reproduction apparatus 10 according to respective embodiments, which includes functions as a content reproduction apparatus, includes:
A. an identification unit (content identification unit 12) configured to identify a series of pieces of content that were recorded or reproduced in chronological order;
B. an acquisition unit (sequence information acquisition unit 14) configured to acquire sequence information that shows time sequence of the series of pieces of content identified by the identification unit;
C. a setting unit (reproduction timing setting unit 15) configured to set respective reproduction timings of the pieces of content reproduced in a sequence corresponding to the sequence information; and
D. a reproduction control unit (reproduction control unit 16) configured to perform control so as to reproduce the identified pieces of content at the reproduction timings set by the setting unit.

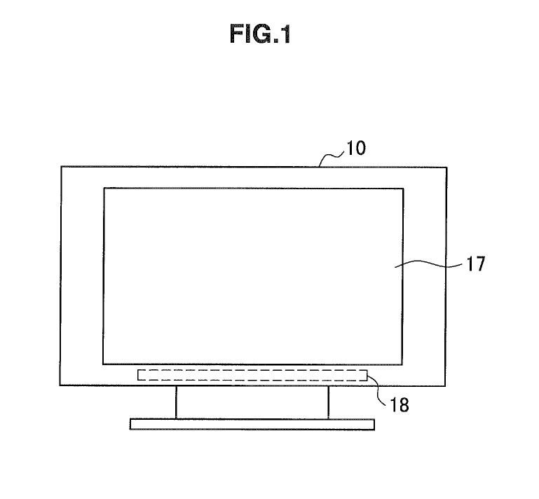

With reference to FIG. 1, there will be described a brief description of a reproduction system common to the embodiments.

FIG. 1 is an explanatory diagram showing an appearance of a content reproduction apparatus realizing a reproduction system according to an embodiment of the present disclosure. As shown in FIG. 1, a reproduction system according to an embodiment of the present disclosure is realized by the content reproduction apparatus 10.

As shown in FIG. 1, the content reproduction apparatus 10 includes a display unit 17 for displaying an image, and a speaker 18 for outputting an audio signal. The content reproduction apparatus 10 performs control to reproduce content such as image data (moving image data and still image data) and audio signal data, on the display unit 17 and from the speaker 18 in accordance with user instructions. Content to be reproduced may be stored in the content reproduction apparatus 10, or may be acquired from the outside.

In FIG. 1, a household television apparatus (display control apparatus) is illustrated as an example of the content reproduction apparatus 10. However, the content reproduction apparatus 10 is not limited thereto. For example, the content reproduction apparatus 10 may be an information processing apparatus such as a personal computer (PC), a household video processing apparatus (a Blu-ray Disc (BD) recorder, a DVD recorder, a video cassette recorder, and the like), a household audio apparatus (a radio, a radio-cassette recorder, an IC recorder, a portable audio player, a stereo system, and the like), a personal digital assistant (PDA), a household game device, a cellular phone, a smartphone, a portable video processing apparatus, and a portable game device.

(Background)

In the case of reproducing video content or audio content that were recorded or broadcasted in the past, a user generally choose content to watch and listen to, and instructions to start reproduction is issued at user-preferred timings. For example, instruction to start reproduction of the following reproduction target is also issued at user-preferred reproduction timings: pieces of video content of a past event over multiple days, and pieces of video content of a series of a program broadcasted for a certain period of time.

However, such timings of reproduction performed by a user have no relation with schedule of past events, broadcast schedule of a series of a program, and the like. Examples of the past events includes sporting events such as Olympics, world championships, Japan Series in Nippon Professional Baseball, tournaments of high school baseball, honbasho (official professional sumo tournament), and Hakone Ekiden (prominent university relay marathon race), music concerts, competitive eating, and Paris-Dakar Rally. When video content of such events is reproduced at the same timing as actual event schedules at the times, the user can feel realistic sensation as if to watch the events in real time.

Examples of a past series of program includes serial dramas, anime series, lectures by The Open University of Japan (distance learning university), and radio programs that were broadcasted every day or every week in identical time slot. When pieces of video content of such series of program are reproduced at the same timing as actual broadcast schedules at the times, for example, every day or every week in identical time slot, a user can watch the pieces of video content on the same day of the week and the same time slot as the past so as to feel more nostalgia and realistic sensation.

Therefore, with the above circumstance taken into point of view, the content reproduction apparatus 10 according to respective embodiments of the present disclosure has been achieved. It is possible for a content reproduction apparatus 10 according to respective embodiments of the present disclosure to reproduce video data (a series of content) such as a past event and a past series of television program that are chosen by a user, on the basis of intervals corresponding to an actual event schedule and an actual broadcast schedule at the times. Hereinafter, there is subsequently and specifically described the content reproduction apparatus 10 according to the respective embodiments of the present disclosure.

### 2. First Embodiment

### 2-1. Configuration of Content Reproduction Apparatus According to First Embodiment

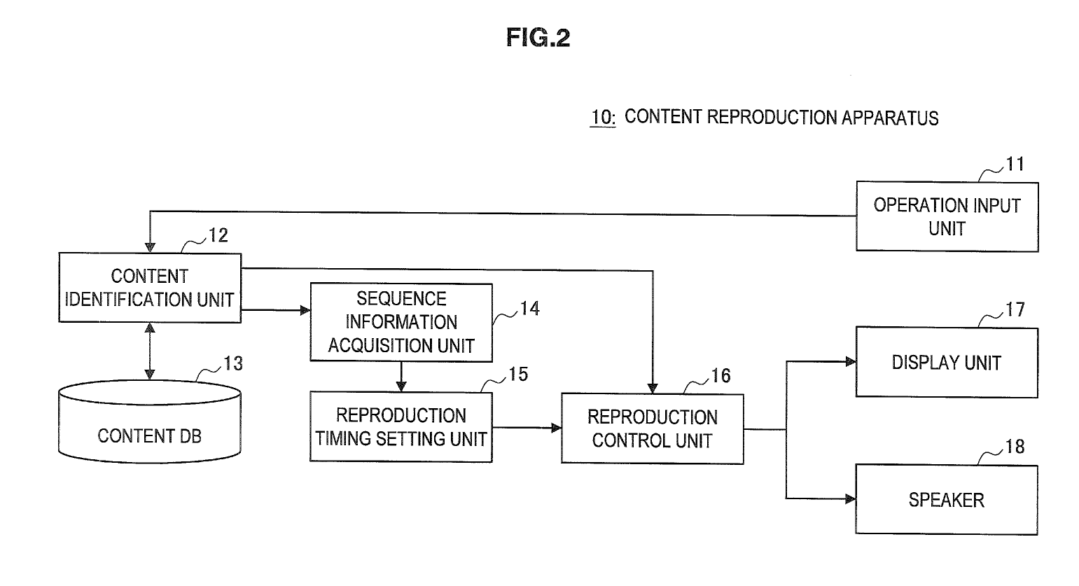

FIG. 2 is a block diagram showing an internal configuration of a content reproduction apparatus 10 according to a first embodiment. As shown in FIG. 2, the content reproduction apparatus 10 according to the first embodiment includes an operation input unit 11, a content identification unit 12, a content data base (DB) 13, a sequence information acquisition unit 14, a reproduction timing setting unit 15, a reproduction control unit 16, a display unit 17, and a speaker 18. Note that, since the description is made with reference to FIG. 1 in the former section, the repeated description of the display unit 17 and the speaker 18 will be omitted hereafter.

(Operation Input Unit)

The operation input unit 11 detects a user operation and outputs the detected user operation as input data to the content identification unit 12. For example, the operation input unit 11 receives infrared data communication from a remote controller (not shown) operated by a user, and detects the user operation.

(Content Identification Unit)

The content identification unit 12 identifies content reproduced in response to a user instruction, and supplies the sequence information acquisition unit 14 with the identified content. The identified content may be extracted from content stored in the content DB 13, or may be acquired from the outside. The content identified by the content identification unit 12 is a series of pieces of content that were recorded or reproduced in chronological order. Examples of the series of pieces of content include pieces of video content of an event over multiple days, and pieces of video content of a program broadcasted for a certain period of time. The video content of an event includes recorded data in a recorder for home use. For example, when instruction to reproduce “Tokyo Olympics” is issued by a user, the content identification unit 12 identifies pieces of video content including an opening ceremony and games at the Tokyo Olympics.

(Content DB)

The content DB 13 stores various types of content that may be reproduced by the content reproduction apparatus 10. As described above, the various types of content include a series of pieces of content that were recorded or reproduced in chronological order. Examples of the various types of content include audio/video content of an event done in the past and audio/video content of a program broadcasted in the past. With the various types of content, schedule information showing a schedule of an event, a broadcast schedule of a series of a program, or the like is associated.

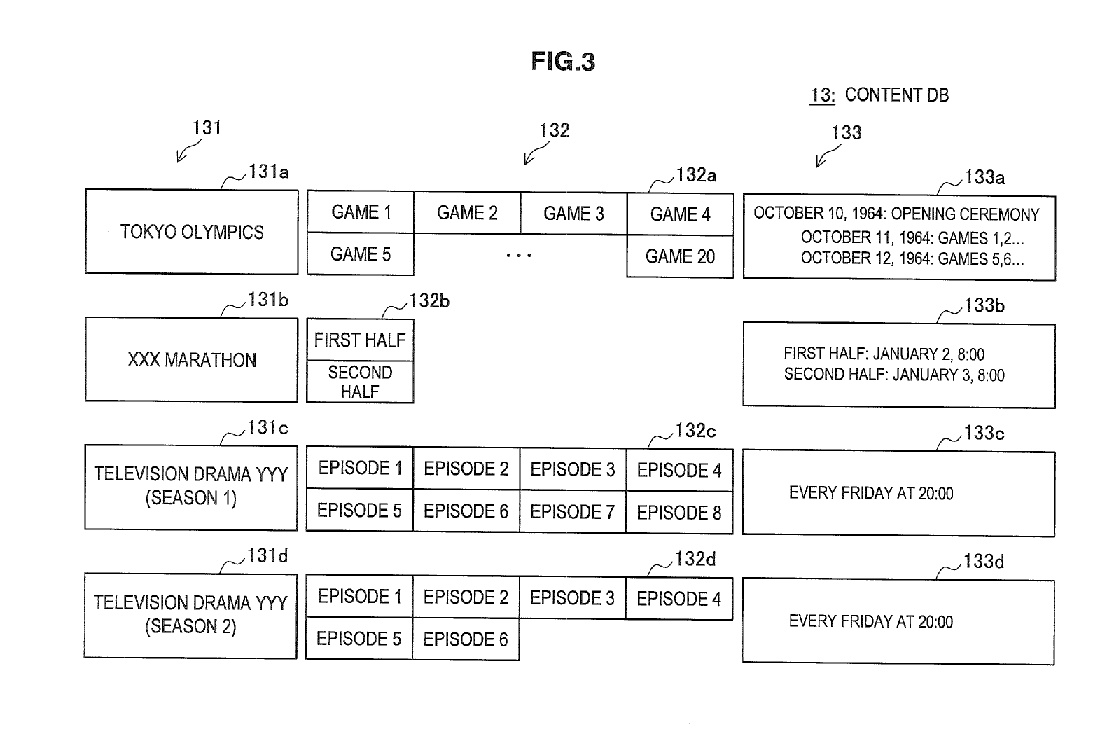

Here, an example of various types of content stored in the content DB 13 will be described with reference to FIG. 3. As shown in FIG. 3, the content DB 13 stores generic names (titles) 131 of multiple series of pieces of content, the multiple series of pieces of content 132, and pieces of schedule information 133 in a manner that they are associated with each other.

For example, as “Tokyo Olympic” (generic name 131a), various types of video content (a series of pieces of content 132a) of Game 1 to Game 20 played in the past Tokyo Olympics and a schedule (schedule information 133a) of the Tokyo Olympics are stored. The schedule information 133a includes date and time of an opening ceremony of the Tokyo Olympics and a schedule of games, such as what sport is played at what time in what day.

As “XXX marathon” (generic name 131b), respective pieces of video content (a series of pieces of content 132b) of a first half and a second half of the marathon and a schedule (schedule information 133b) of the marathon are stored. The schedule information 133b includes date and time, a schedule, and the like of the marathon, such as a start time of the first half of the marathon in day 1, and a start time of the second half of the marathon in day 2.

As “television drama YYY, season 1” (generic name 131c), there are stored respective pieces of video content (a series of pieces of content 132c) of episode 1 to episode 8 of a series of a program broadcasted in the past and a broadcast schedule (schedule information 133c) of the program. The schedule information 133c includes a broadcast schedule showing that “television drama YYY season 1” was broadcasted every Friday at 20:00, for example.

As “television drama YYY, season 2” (generic name 131d), there are stored respective pieces of video content (a series of pieces of content 132d) of episode 1 to episode 6 of a series of a program broadcasted in the past and a broadcast schedule (schedule information 133d) of the program. The schedule information 133c includes a broadcast schedule showing that “television drama YYY season 2” was broadcasted every Friday at 20:00, which followed the same schedule as “television drama YYY, season 1”, for example.

(Sequence Information Acquisition Unit)

The sequence information acquisition unit 14 acquires sequence information that shows time sequence of the series of pieces of content identified by the identification unit 12. The sequence information may be a time stamp that is information about time added to respective series of pieces of content, a number showing a chronological order, and the like. For example, when video content including episodes of a series of a program broadcasted in the past are identified as a series of pieces of content, the sequence information acquisition unit 14 acquires time sequence on the basis of episode code numbers or sequential numbers included in respective titles of the video content.

In addition, the sequence information acquisition unit 14 may acquire sequence information on the basis of schedule information associated with a series of pieces of content. For example, when pieces of video content of games in the Tokyo Olympics are identified as the series of pieces of content, the sequence information acquisition unit 14 acquires sequence of the games sequentially played in the Olympics on the basis of schedule information 133a.

(Reproduction Timing Setting Unit)

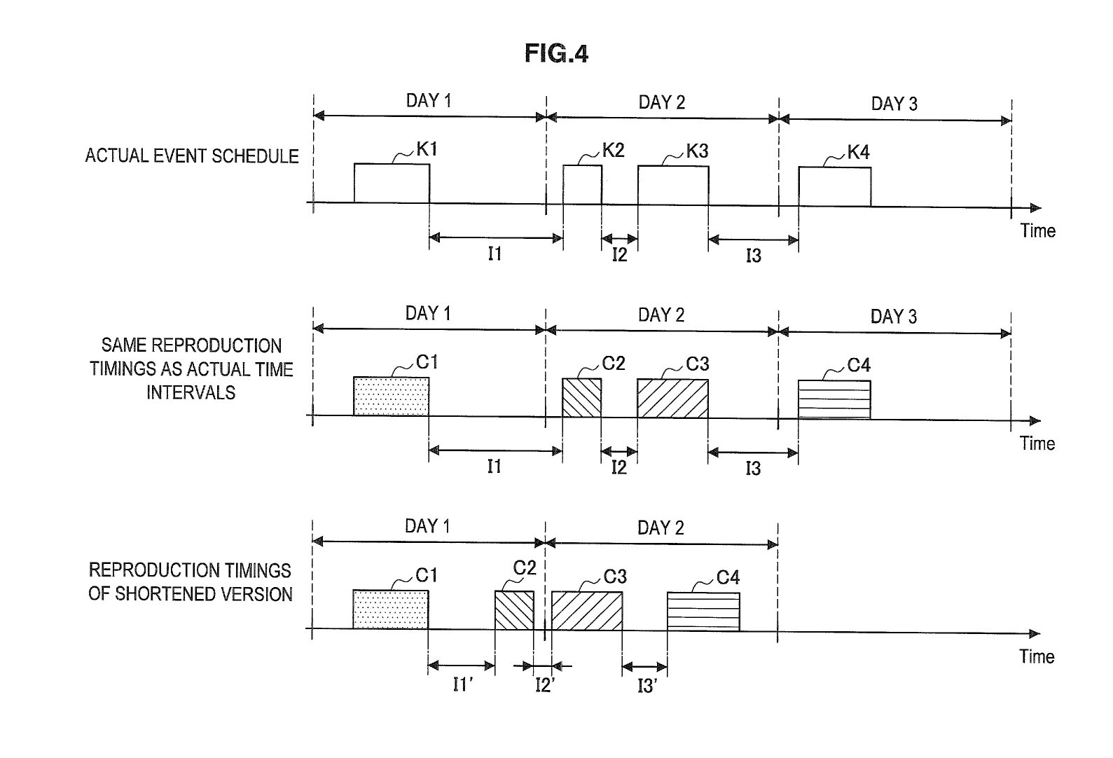

The reproduction timing setting unit 15 sets respective reproduction timings of a series of pieces of content reproduced in a sequence corresponding to the sequence information acquired by the sequence information acquisition unit 14. More specifically, the reproduction timing setting unit 15 refers schedule information (a schedule of an event, a broadcast schedule of a program, or the like) associated with the series of pieces of content, and then sets the reproduction timings on the basis of actual time intervals. With reference to FIG. 4, an example of setting of reproduction timings will be described.

FIG. 4 is a diagram showing an example of setting of reproduction timings based on actual time intervals. An upper part of FIG. 4 shows a schedule of an event, the event being an actual event that was held for three days. For example, when a sporting event was held, the diagram shows that a game K1 was played on day 1, games K2 and K3 were played on day 2, and a game K4 was played on day 3. Such event schedule is acquired on the basis of the schedule information 133 that is associated with a series of pieces of content and that is stored in the content DB 13.

The reproduction timing setting unit 15 sets reproduction timings to the same time intervals as actual time intervals of pieces of content that was recorded or reproduced in chronological order, for example. Specifically, as shown in the middle part of FIG. 4, reproduction timings of pieces of video content C1 to C4 in which the games K1 to K4 were recorded, respectively, is set to the same time intervals as actual time intervals shown in the upper part of FIG. 4.

The reproduction timing setting unit 15 may also sets reproduction timings of the respective pieces of video content C1 to C4 to the same time slots as time slots in the past chronological order. In this case, the reproduction timing setting unit 15 may set reproduction timings in view of a time difference between a country where the event was held and a country where the user lives, or may set reproduction timings without considering the time difference.

On the other hand, a reproduction-start timing of the video content C1 may be a time when the user performs instructions to start reproduction of the event, and may differ from an actual time when the event started. In this case, the reproduction timing setting unit 15 sets a reproduction timing of the video content C2 to a timing after the reproduction of the video content C1 and after a time interval I1. The time interval I1 is the same time interval as an actual time interval between the game K1 and the game K2 as shown in the upper part of FIG. 4. After that, the reproduction timing setting unit 15 sets a reproduction timing of the video content C3 to a timing after a time interval I2, and sets a reproduction timing of the video content C4 to a timing after a time interval I3. As described above, by providing the same time intervals as actual time intervals between games, the user feels like watching the event in real time and enjoys the event more.

In the case of a series of a program that were broadcasted every Friday at 20:00, the reproduction timing setting unit 15 sets reproduction timings to every Friday at 20:00 similarly. When pieces of video content of the past television advertisements (TV ads) are associated with pieces of video content of the series of the program, the reproduction timing setting unit 15 may set reproduction timings of the pieces of video content of TV ads to timings before, during, and after the pieces of video content of the series of the program. In this way, the user feels nostalgia by watching past television programs on the same day of the week and in the same time slot as the past; the user feels more nostalgia by watching past TV ads before, during, and after the television programs; and the user enjoys the past television programs more.

The above-described examples recreate the same chronological order as the past chronological order. However, settings of reproduction timings according to an embodiment of the present disclosure are not limited thereto. For example, reproduction timings may be set to reproduction timing obtained by shortening past chronological order. For example, as shown in the upper part of FIG. 4, when the event that was held for three days is reproduced in two days, the reproduction timing setting unit 15 shortens the time intervals I1 to I3 between games at the same ratios and sets reproduction timings of the pieces of video content C1 to C4 of respective games. More specifically, as shown in lower part of FIG. 4, the reproduction timing of the pieces of video content C1 to C4 in which the games K1 to K4 were recorded, respectively, is set to time intervals I1′ to I3′ obtained by shortening the actual time intervals I1 to I3, respectively, as shown in upper part of FIG. 4.

As described above, the reproduction timing setting unit 15 sets reproduction timings to reproduction timings obtained by shortening the actual time intervals of pieces of content that were recorded or reproduced in chronological order. Therefore, even if the content were reproduced in the number of days less than the number of days of actual schedule, the user enjoys the event on the basis of the actual schedule (chronological order) and convenience is improved.

The reproduction timing setting unit 15 can set reproduction timings not only to reproduction timings obtained by shortening time intervals, but also to reproduction timings obtained by lengthening the time intervals. Therefore, the user enjoys past events longer than actual schedules, and convenience is improved.

Moreover, the reproduction timing setting unit 15 may shorten or lengthen some time intervals to set reproduction timings with reference to schedule information of the user. For example, when a series of a program are reproduced at predetermined time on predetermined day of the every week, the reproduction timing setting unit 15 normally sets a reproduction timing of next content to a week later. However, when the user plans to go out the week later, the reproduction timing setting unit 15 exceptionally sets a reproduction timing of next content to an additional week later.

In addition, the reproduction timing setting unit 15 may set reproduction timings of some pieces of content among a series of pieces of content. For example, when reproducing professional baseball pennant races (round-robin tournament) held for a certain period of time, the reproduction timing setting unit 15 sets a reproduction timing of pieces of video content in which user's favorite team won, on the basis of user's preference. For example, when the user's favorite team won in the pieces of video content C2 and C4 among the pieces of video content C1 to C4 shown in FIG. 4, the reproduction timing setting unit 15 sets a reproduction timing of the video content C2 to day 2 and sets a reproduction timing of the video content C4 to day 3 on the basis of actual time intervals. Therefore, the user enjoys predetermined parts of the past event, and convenience is improved.

(Reproduction Control Unit)

The reproduction control unit 16 performs control so as to reproduce content identified by the content identification unit 12 at the reproduction timing set by the reproduction timing setting unit 15. Specifically, on the basis of a timing set by the reproduction timing setting unit 15, the reproduction control unit 16 performs control so as to display the pieces of video content identified by the content identification unit 12 on the display unit 17. Furthermore, on the basis of a timing set by the reproduction timing setting unit 15, the reproduction control unit 16 performs control so as to output audio content identified by the content identification unit 12 from the speaker 18.

### 2-2. Operation of Content Reproduction Apparatus According to First Embodiment

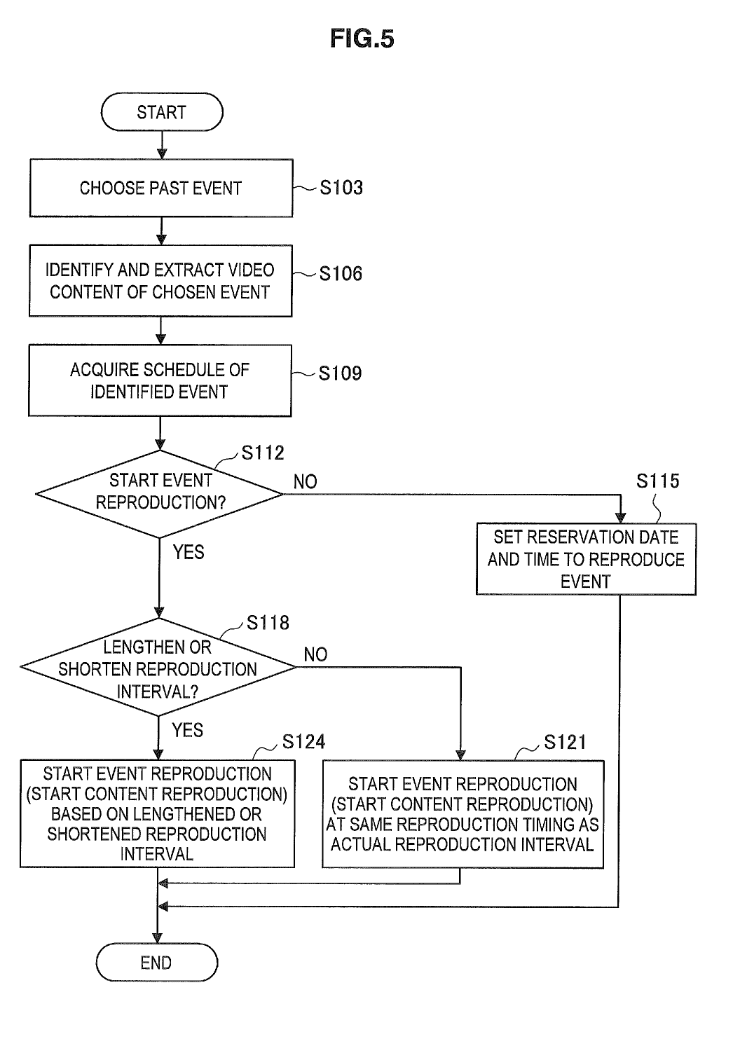

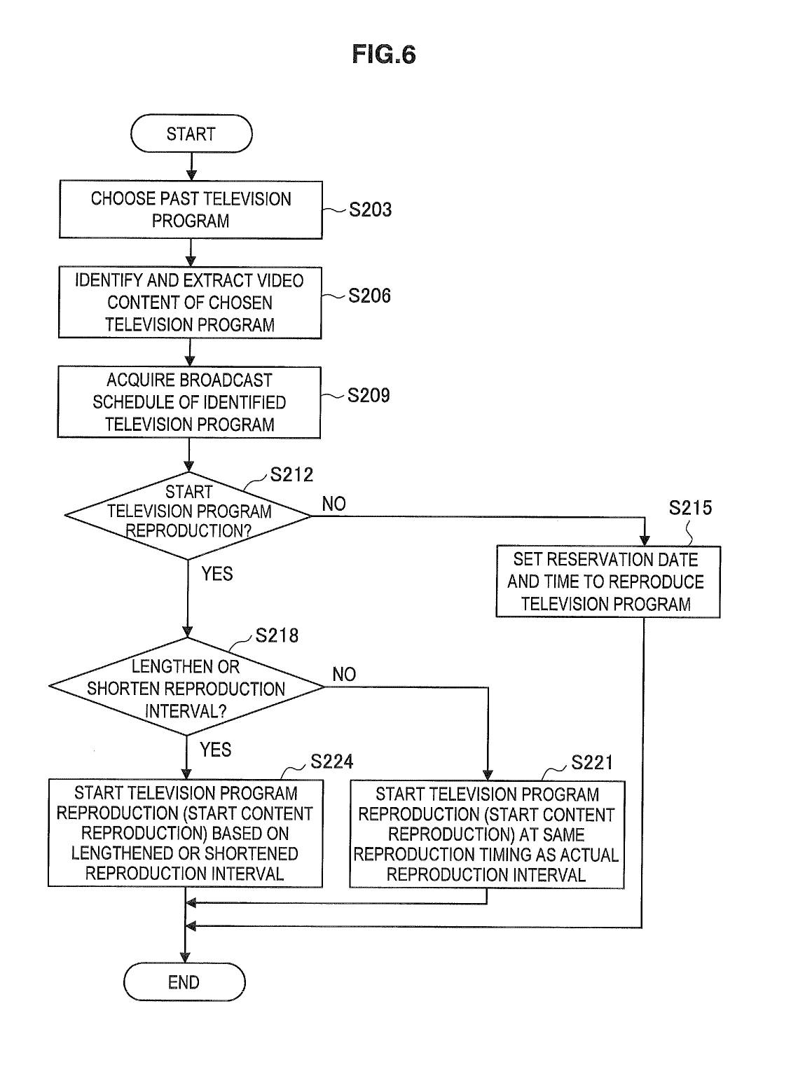

In the above paragraphs, there is described the configuration of the content reproduction apparatus 10 according to the first embodiment. Subsequently, with reference to FIG. 5 and FIG. 6, there will be described the operation of the content reproduction apparatus 10 according to the first embodiment.

FIG. 5 is a flowchart showing operation processing in the case where the content reproduction apparatus 10 according to the first embodiment reproduces a past event. As shown in FIG. 5, in step S103, the operation input unit 11 firstly detects a user operation and receives a user choice of the past event. The past event is an event which had been held over multiple days. Examples of the past event include Tokyo Olympics, Sapporo Winter Olympics, Nagano Winter Olympics, World Series of North American-based Major League Baseball, and a knockout stage of FIFA World Cup in South Africa.

Subsequently, in step S106, the content identification unit 12 identifies a series of pieces of video content of the event chosen by the user, and extracts the identified series of pieces of video content from the content DB 13.

Subsequently, in step S109, the reproduction timing setting unit 15 acquires a schedule (schedule information 133) of the identified event so as to set respective reproduction timings of the series of pieces of content to be reproduced in a sequence corresponding to the sequence information acquired by the sequence information acquisition unit 14. The schedule information 133 is associated with the series of pieces of content and is stored in the content DB 13.

Subsequently, in step S112, the reproduction timing setting unit 15 decides whether or not event reproduction is immediately started. For example, when the reproduction timing is set in a manner that the pieces of content is reproduced at the same time as the actual schedule, the reproduction timing setting unit 15 compares the actual schedule with a current time, and decides whether or not it is possible to immediately start event reproduction. On the other hand, when the reproduction timing is not restricted to the same time as the actual schedule, the reproduction timing setting unit 15 decides that the event reproduction can be immediately started.

When the event reproduction is not started immediately (NO in S112), the reproduction timing setting unit 15 sets, in step S115, reservation date and time to reproduce the event.

On the other hand, when the event reproduction is started immediately (YES in S112), the reproduction timing setting unit 15 decides, in step S118, whether or not a reproduction interval between reproduction timings is lengthened or shortened. Lengthening or Shortening of the reproduction interval between the reproduction timings may be decided on the basis of user instructions. For example, when there are user instructions that the event is reproduced within one week, the reproduction timing setting unit 15 decides to shorten the interval in the case where the schedule of the event to be reproduced is over one week, and decides not to shorten the interval in the case where the schedule of the event to be reproduced is within one week. For another example, when there are user instructions that the event is reproduced for exactly one month, the reproduction timing setting unit 15 decides to lengthen a reproduction schedule so that the event is reproduced for exactly one month, in the case where the schedule of the event to be reproduced is less than one month.

When lengthening or shortening is not performed (NO in S118), the reproduction timing setting unit 15 sets, in step S121, the reproduction timings using the same time intervals as actual time intervals based on the schedule information 133. On the basis of the reproduction timings set by the reproduction timing setting unit 15, the reproduction control unit 16 starts the event reproduction, that is, reproduction of pieces of video content.

On the other hand, when lengthening or shortening is performed (YES in S118), the reproduction timing setting unit 15 sets, in step S124, the reproduction timings using time intervals obtained by lengthening or shortening actual time intervals based on the schedule information 133 at a predetermined rate. On the basis of the reproduction timings set by the reproduction timing setting unit 15, the reproduction control unit 16 starts the event reproduction, that is, reproduction of pieces of video content.

In the above paragraphs, there is specifically described operation processing in the case where a past event is reproduced by the content reproduction apparatus 10 according to an embodiment of the present disclosure. With reference to FIG. 6, another operation processing according to an embodiment of the present disclosure will be described.

FIG. 6 is a flowchart showing operation processing in the case where the content reproduction apparatus 10 according to the first embodiment reproduces a past television program. As shown in FIG. 6, in step S203, the operation input unit 11 firstly detects a user operation and receives user choice of the past television program. The past television program is a series of a past program broadcasted periodically, such as every day or every week, for a certain period of time.

Subsequently, in step S206, the content identification unit 12 identifies a series of pieces of video content of the television program (specifically, video content of respective episodes included in the series of the program) chosen by the user, and extracts the series of pieces of video content from the content DB 13.

Subsequently, in step S209, the reproduction timing setting unit 15 acquires a broadcast schedule (schedule information 133) of the identified television program, so as to set respective reproduction timings of the series of pieces of content reproduced in a sequence corresponding to the sequence information acquired by the sequence information acquisition unit 14. The schedule information 133 is associated with the series of pieces of content and is stored in the content DB 13.

Subsequently, in step S212, the reproduction timing setting unit 15 decides whether or not television program reproduction is immediately started. For example, when the reproduction timing is set in a manner that the television program is reproduced at the same schedule as the actual schedule (day of the week, time, and date), the reproduction timing setting unit 15 compares the actual schedule with a current day of the week, a current time, and a current date, and decides whether or not it is possible to immediately start television program reproduction. On the other hand, when the reproduction timing is not restricted to the same schedule as the actual schedule, the reproduction timing setting unit 15 decides that the television program reproduction can be immediately started.

When the television program reproduction is not started immediately (NO in S212), the reproduction timing setting unit 15 sets, in step S215, reservation date and time to reproduce the television program.

On the other hand, when the television program reproduction is started immediately (YES in S212), the reproduction timing setting unit 15 decides, in step S218, whether or not a reproduction interval between reproduction timings is lengthened or shortened. Lengthening or Shortening of the reproduction interval between reproduction timings may be decided on the basis of user instructions. For example, when there are user instructions to reproduce a television program “every day”, the reproduction timing setting unit 15 decides to shorten intervals so as to set the reproduction timings to “every day” in the case where the actual schedule of the series of the program to be reproduced is set to “every week”, and decides not to shorten or lengthen the intervals in the case where the actual schedule of the series of the program to be reproduced is set to “every week”. For another example, when there are user instructions to reproduce a television program “every two weeks”, the reproduction timing setting unit 15 decides to lengthen intervals so as to set the reproduction timings to “every two weeks” in the case where the actual schedule of the series of the program to be reproduced is set to “every week”.

When lengthening or shortening is not performed (NO in S218), the reproduction timing setting unit 15 sets, in step S221, the reproduction timings using the same time intervals as actual time intervals based on the schedule information 133. For example, when a reproduction schedule is set to once every week, the reproduction timing setting unit 15 starts reproduction of episode 1 of a television program (video content), and sets a reproduction timing of episode 2 of the television program to a week after the reproduction. Then, on the basis of the reproduction timing set by the reproduction timing setting unit 15, the reproduction control unit 16 starts the television-program reproduction, that is, reproduction of pieces of video content.

On the other hand, when lengthening or shortening is performed (YES in S218), the reproduction timing setting unit 15 sets, in step S224, the reproduction timings using time intervals obtained by lengthening or shortening actual time intervals based on the schedule information 133 at a predetermined rate. For example, when shortening a broadcast schedule in which respective episodes were broadcasted once a week to once a day, the reproduction timing setting unit 15 starts reproduction of episode 1 of a television program (video content), and sets a reproduction timing of episode 2 of the television program to a day after the reproduction. Then, on the basis of the reproduction timings set by the reproduction timing setting unit 15, the reproduction control unit 16 starts the television-program reproduction, that is, reproduction of pieces of video content.

### 3. Second Embodiment

In the above paragraphs, the first embodiment of the present disclosure is described. Subsequently, a second embodiment of the present disclosure will be described.

### 3-1. Entire Configurations of Reproduction System

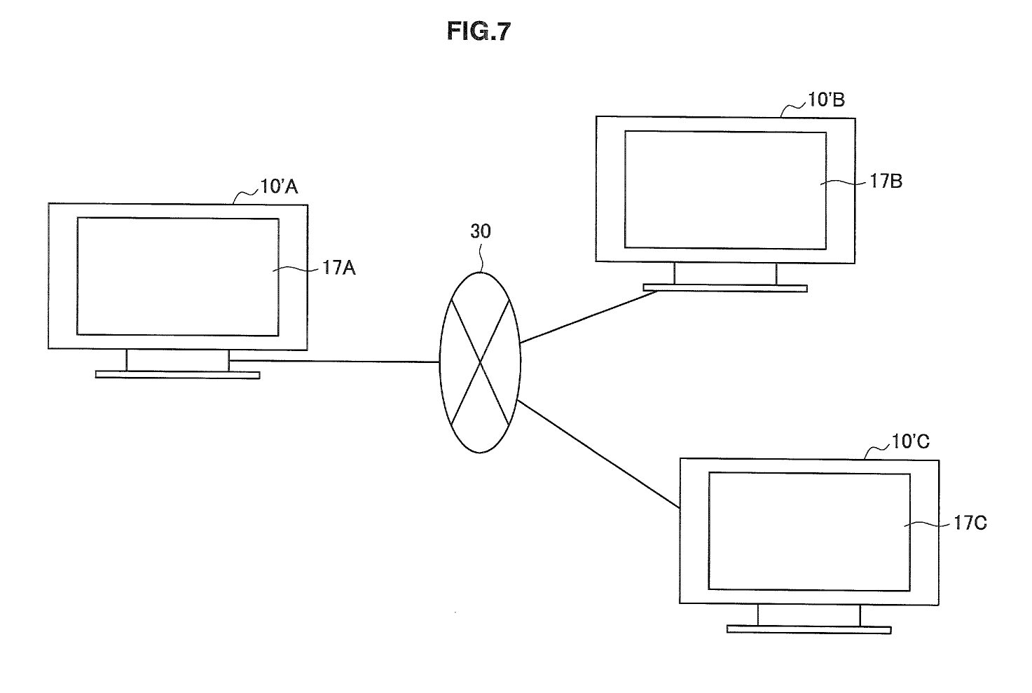

FIG. 7 is a diagram showing entire configurations of a reproduction system according to the second embodiment. As shown in FIG. 7, the reproduction system includes content reproduction apparatuses 10′A to 10′C. Respective content reproduction apparatuses 10′A to 10′C are connected to each other via a network 30, and can establish a social network. Respective content reproduction apparatuses 10′A to 10′C can reproduce events and series of programs by displaying pieces of video content of the events and the series of programs on display units 17A to 17C.

In such a system configuration, respective content reproduction apparatuses 10′A to 10′C reproduce an identical event and an identical series of a program on the basis of an identical time interval, so that people can together enjoy past events and past series of programs, and convenience and entertainment characteristics of the content reproduction apparatus are improved. In addition, convenience and entertainment characteristics of the content reproduction apparatus are further improved by sharing reviews among users.

### 3-2. Configuration of Content Reproduction Apparatus According to Second Embodiment

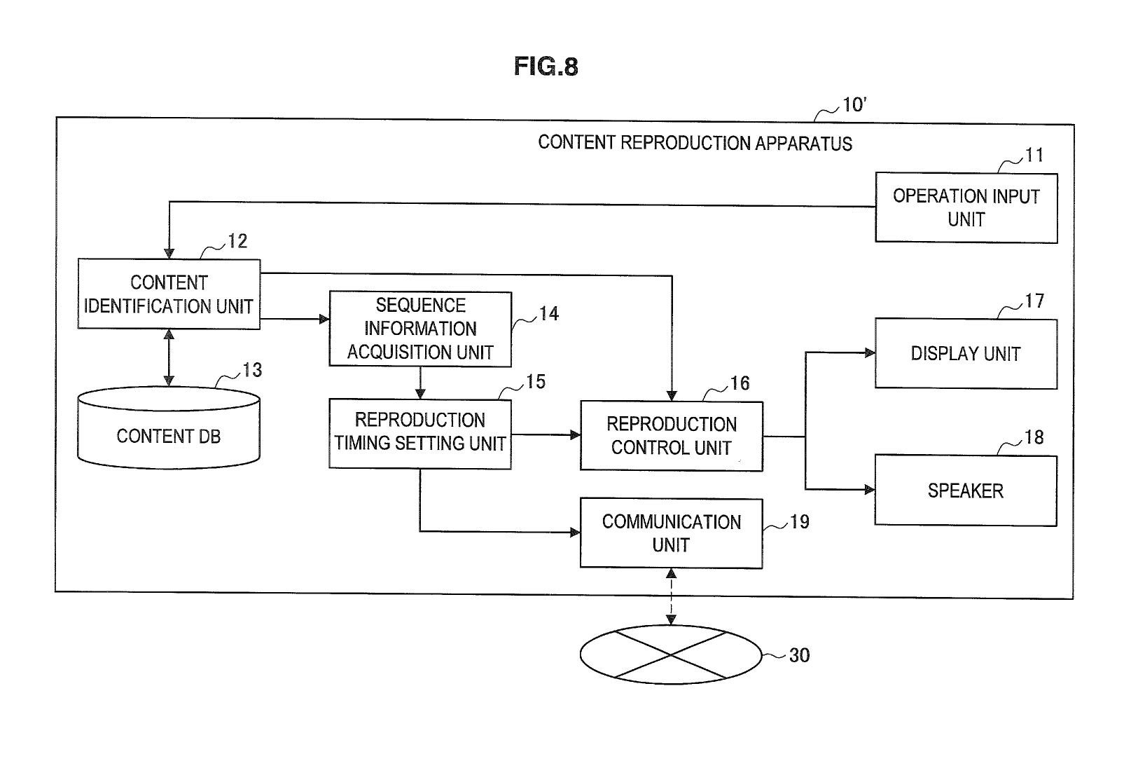

FIG. 8 is an explanatory diagram showing a configuration of a content reproduction apparatus 10′ according to the second embodiment. As shown in FIG. 8, the content reproduction apparatus 10′ according to the second embodiment includes an operation input unit 11, a content identification unit 12, a content DB 13, a sequence information acquisition unit 14, a reproduction timing setting unit 15, a reproduction control unit 16, a display unit 17, a speaker 18, and a communication unit 19. Note that, since the description is made in “2. First embodiment,” the repeated descriptions of the operation input unit 11, the content identification unit 12, the content DB 13, the sequence information acquisition unit 14, the reproduction timing setting unit 15, the reproduction control unit 16, the display unit 17, and the speaker 18 will be omitted hereafter.

The content reproduction apparatus 10′ according to the second embodiment shares reproduction timings of a series of pieces of content, such as a past event chosen by a user, with another content reproduction apparatus 10′. Accordingly, content reproduction apparatuses 10′ can reproduce a past event or the like at an identical timing. Specifically, the communication unit 19 transmits a reproduction timing set by the reproduction timing setting unit 15 of the content reproduction apparatus 10′ to the other content reproduction apparatus 10′ via a network 30.

The communication unit 19 also can receive a reproduction timing set by another content reproduction apparatus 10′ via the network 30. In this case, on the basis of the reproduction timing received by the communication unit 19, the reproduction control unit 16 performs control so as to reproduce a series of pieces of content.

As described above, by providing communication units 19, content reproduction apparatuses 10′ according to the second embodiment can share reproduction timings among the content reproduction apparatuses 10′. Note that a series of pieces of content reproduced by respective content reproduction apparatuses 10′ is identified by respective content identification units 12, and extracted from respective content DB's 13 of the respective content reproduction apparatuses 10′ or the outside.

### 3-3. Operation of Content Reproduction Apparatus According to Second Embodiment

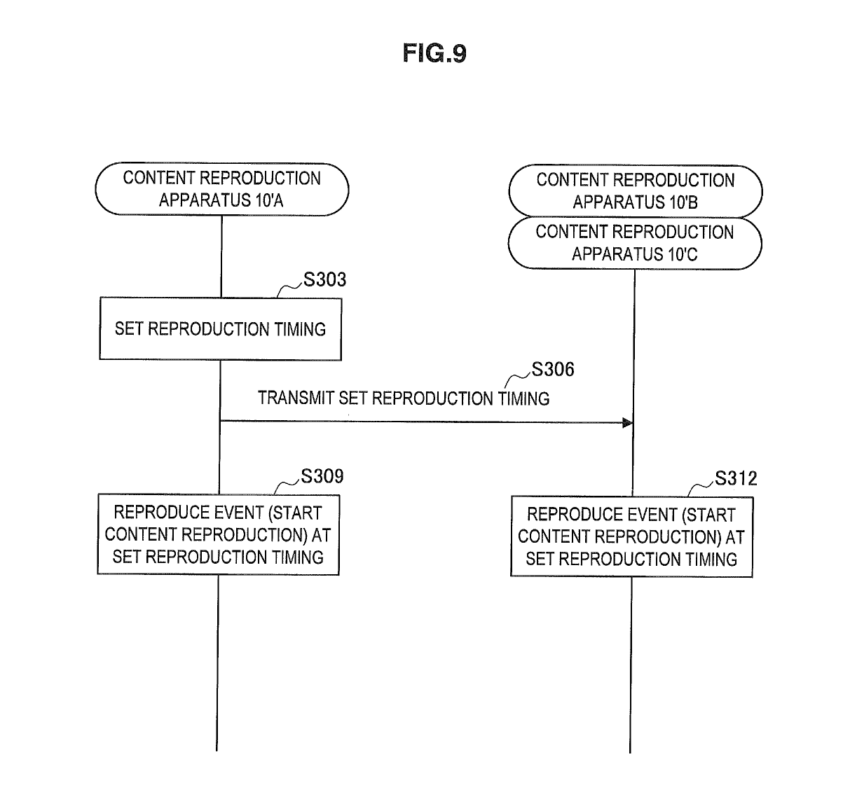

Next, with reference to FIG. 9, there will be described operation processing according to the present embodiment. FIG. 9 is a sequence diagram showing reproduction timing setting processing by the content reproduction apparatus 10′ according to the second embodiment.

As shown in FIG. 9, in step S303, a reproduction timing setting unit 15 of a content reproduction apparatus 10′A firstly sets reproduction timings of a series of pieces of content. Note that, since the description is made in “2. First embodiment,” the repeated description of setting of the reproduction timings will be omitted here.

In step S306, a communication unit 19 of the content reproduction apparatus 10′A subsequently transmits the set reproduction timings to other content reproduction apparatuses 10′B and 10′C via a network 30.

In step S309, on the basis of the reproduction timings set by the reproduction timing setting unit 15, a reproduction control unit 16 of the content reproduction apparatus 10′A subsequently starts reproduction of events or the like, that is, reproduction of video content.

In step S312, on the basis of the reproduction timings received by the content reproduction apparatus 10′A, reproduction control units 16 of the content reproduction apparatuses 10′B and 10′C subsequently start reproduction of the events or the like, that is, reproduction of video content.

### 4. Conclusion

As explained above, according to the embodiments of the present disclosure, reproduction timings of past events, past television programs and the like can be automatically set by using time intervals corresponding to actual time intervals based on schedule information of the past events, the past television programs and the like that are chosen by a user, and the events, the television programs and the like can be reproduced at the set reproduction timings. Accordingly, the user can feel realistic sensation as if to watch the events in real time. In addition, by periodical reproduction of a series of program on the same day of the week and in the same time slot as the past, the user feels more nostalgia and can live his/her life with realistic sensation for the past for a certain period of time.

Time intervals corresponding to actual time intervals may be the same time intervals as the actual time intervals, or may be time intervals obtained by shortening or lengthening the actual time intervals. In this way, since a reproduction period can be adjusted to a schedule of the user, convenience of the content reproduction apparatus 10 is improved.

In addition, since content reproduction apparatuses can share reproduction timings of events, television programs and the like according to the embodiments of the present disclosure, people can together enjoy the past events and the past television programs, and convenience and entertainment characteristics of content reproduction apparatus are improved.

It should be understood by those skilled in the art that various modifications, combinations, sub-combinations and alterations may occur depending on design requirements and other factors insofar as they are within the scope of the appended claims or the equivalents thereof.

For example, it is not necessary for respective steps in processing by the content reproduction apparatus 10 according to an embodiment of the present disclosure to be processed in chronological order based on an order of the flowchart. For example, respective steps in processing by the content reproduction apparatus 10 may be processed in order different from the order of the flowchart, or may be processed in parallel.

Further, it is also possible to create a computer program for causing hardware such as a CPU, ROM, and RAM, which are built in the content reproduction apparatus 10, to exhibit substantially the same functions as those of respective structures of the content reproduction apparatus 10 described above. Further, there is also provided a storage medium having the computer program stored therein.

Additionally, the present technology may also be configured as below.
(1) A content reproduction apparatus including:

an identification unit configured to identify a series of pieces of content that were recorded or reproduced in chronological order;

an acquisition unit configured to acquire sequence information that shows time sequence of the series of pieces of content identified by the identification unit;

a setting unit configured to set respective reproduction timings of the pieces of content reproduced in a sequence corresponding to the sequence information; and

a reproduction control unit configured to perform control so as to reproduce the identified pieces of content at the reproduction timings set by the setting unit.
(2) The content reproduction apparatus according to (1),

wherein the setting unit sets reproduction timings to actual time intervals of pieces of content that were recorded or reproduced in chronological order.
(3) The content reproduction apparatus according to (1),

wherein the setting unit sets reproduction timings to time intervals obtained by lengthening or shortening actual time intervals of pieces of content that were recorded or reproduced in chronological order.
(4) The content reproduction apparatus according to any one of (1) to (3),

wherein the setting unit sets reproduction timings with respect to one or more pieces of content among the pieces of content.
(5) The content reproduction apparatus according to any one of (1) to (4), further including:

a transmitter configured to transmit reproduction timings set by the setting unit to another content reproduction apparatus.
(6) The content reproduction apparatus according to (2) or (3),

wherein the actual time intervals of the pieces of content are time intervals based on schedule information associated with the series of pieces of content that were recorded or reproduced in chronological order.
(7) The content reproduction apparatus according to (6),

wherein the schedule information is a schedule of an event or a broadcast schedule of a program.
(8) A non-transitory computer-readable storage medium having a program stored therein, the program for causing a computer to function as:

an identification unit configured to identify a series of pieces of content that were recorded or reproduced in chronological order;

an acquisition unit configured to acquire sequence information that shows time sequence of the series of pieces of content identified by the identification unit;

a setting unit configured to set respective reproduction timings of the pieces of content reproduced in a sequence corresponding to the sequence information; and

a reproduction control unit configured to perform control so as to reproduce the identified pieces of content at the reproduction timings set by the setting unit.

What is claimed is:

1. A content reproduction apparatus comprising:
an identification unit configured to identify a series of pieces of content that were recorded or reproduced in chronological order;
an acquisition unit configured to acquire sequence information that shows time sequence of the series of pieces of content identified by the identification unit;
a setting unit configured to set respective reproduction timings of the pieces of content reproduced in a sequence corresponding to the sequence information; and
a reproduction control unit configured to perform control so as to reproduce the identified pieces of content at the reproduction timings set by the setting unit.

2. The content reproduction apparatus according to claim 1,
wherein the setting unit sets reproduction timings to actual time intervals of pieces of content that were recorded or reproduced in chronological order.

3. The content reproduction apparatus according to claim 1,
wherein the setting unit sets reproduction timings to time intervals obtained by lengthening or shortening actual time intervals of pieces of content that were recorded or reproduced in chronological order.

4. The content reproduction apparatus according to claim 1,
wherein the setting unit sets reproduction timings with respect to one or more pieces of content among the pieces of content.

5. The content reproduction apparatus according to claim 1, further comprising:
a transmitter configured to transmit reproduction timings set by the setting unit to another content reproduction apparatus.

6. The content reproduction apparatus according to claim 2,
wherein the actual time intervals of the pieces of content are time intervals based on schedule information associated with the series of pieces of content that were recorded or reproduced in chronological order.

7. The content reproduction apparatus according to claim 6,
wherein the schedule information is a schedule of an event or a broadcast schedule of a program.

8. A non-transitory computer-readable storage medium having a program stored therein, the program for causing a computer to function as:
an identification unit configured to identify a series of pieces of content that were recorded or reproduced in chronological order;
an acquisition unit configured to acquire sequence information that shows time sequence of the series of pieces of content identified by the identification unit;
a setting unit configured to set respective reproduction timings of the pieces of content reproduced in a sequence corresponding to the sequence information; and
a reproduction control unit configured to perform control so as to reproduce the identified pieces of content at the reproduction timings set by the setting unit.
